(19) United States
(12) Patent Application Publication
(10) Pub. No.: US 2025/0031900 A1
(43) Pub. Date: Jan. 30, 2025

(54) MACHINE FOR DISPENSING AN INFUSION BEVERAGE AND RELATED METHOD

(71) Applicant: LELIT S.R.L., Castegnato (Brescia) (IT)

(72) Inventor: Mauro EPIS, Castegnato (Brescia) (IT)

(21) Appl. No.: 18/696,650

(22) PCT Filed: Oct. 21, 2022
(86) PCT No.: PCT/IB2022/060141

§ 371 Date: Mar. 28, 2024

(30) Foreign Application Priority Data
Nov. 30, 2021 (IT) 102021000030329

(51) Int. Cl. A47J 31/56; A47J 31/44; A47J 31/52; A47J 31/54

(52) U.S. Cl. CPC A47J 31/56; A47J 31/4489; A47J 31/5253; A47J 31/545; A47J 2202/00

(57) ABSTRACT

A machine for dispensing a hot infusion beverage having at least one main boiler provided with main heating elements for heating an infusion liquid is provided. An electronic control unit operatively connected to the main heating elements is programmed to control the main heating elements so as to cause overheating of the infusion liquid at a temperature higher than a desired target temperature, for a predetermined time interval.

The present invention relates to a machine and a method for dispensing an infusion beverage, such as coffee, chamomile, tea, or herbal tea.

In some types of machines for professional or domestic use, whereto the present invention is targeted, special attention is paid to the heating step of the infusion liquid insofar as it is known that if the heating is performed in a slow and controlled manner, the infused beverage has significantly higher organoleptic properties than a beverage obtained by heating the infusion liquid quickly and abruptly.

Furthermore, in some machines, such as those using an infuser group of the type described in U.S. Pat. No. 3,314,357 (known by the trade name E61®), there is a pre-infusion step wherein the hot infusion liquid, for example water, remains in contact for a few seconds with the aromatic substance, for example the coffee powder contained within a filter holder, before the dispensing of the beverage takes place.

In this type of machine, it is essential that the temperature of the infusion liquid remains as constant as possible during the pre-infusion and dispensing steps.

Some machines of this type, such as those using the E61® group, heat the infusion liquid by means of a radiator circuit with a heat exchanger.

One disadvantage of these machines is that the time interval required to bring the infusion liquid and dispensing group to the desired temperature is as long as 40-50 minutes.

Nevertheless, these machines are no longer compatible with current energy-saving standards insofar as the time required in order to be able to bring the infusion group to the dispensing start condition is greater than that imposed for stand-by and energy-saving.

The object of the present invention is to propose a machine of the aforementioned type which, without compromising the high quality of the beverage dispensed, has a lower heating time and is compatible with the required energy-saving standards.

This object is achieved with a machine for dispensing an infusion beverage according to claim 1 and with a method for controlling a machine for dispensing an infusion beverage according to claim 10. The dependent claims describe preferred embodiments of the invention.

The features and advantages of the machine and method for dispensing the infusion beverage according to the invention will become apparent from the following detailed description of its preferred embodiments, given by way of non-limiting example, with reference to the accompanying figures, wherein:

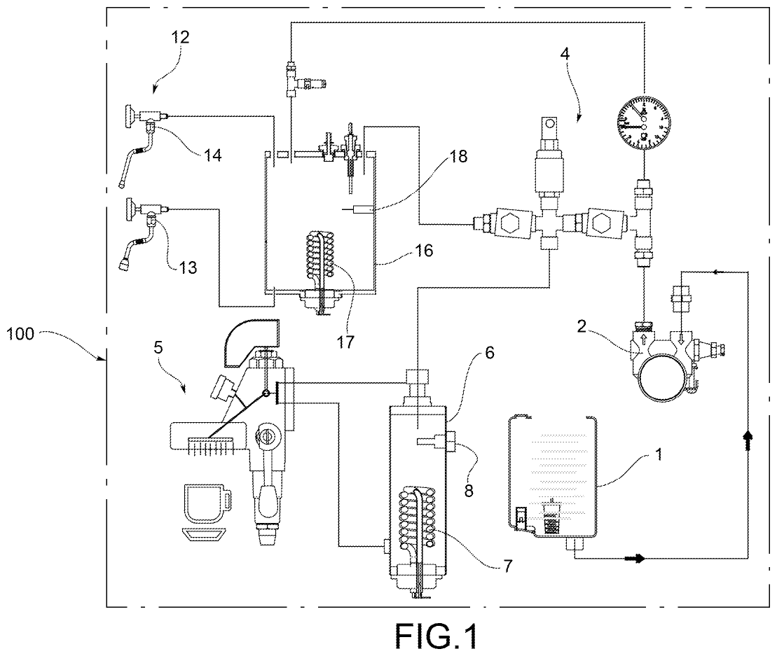

FIG. 1 is a hydraulic diagram of the machine for dispensing an infused beverage;

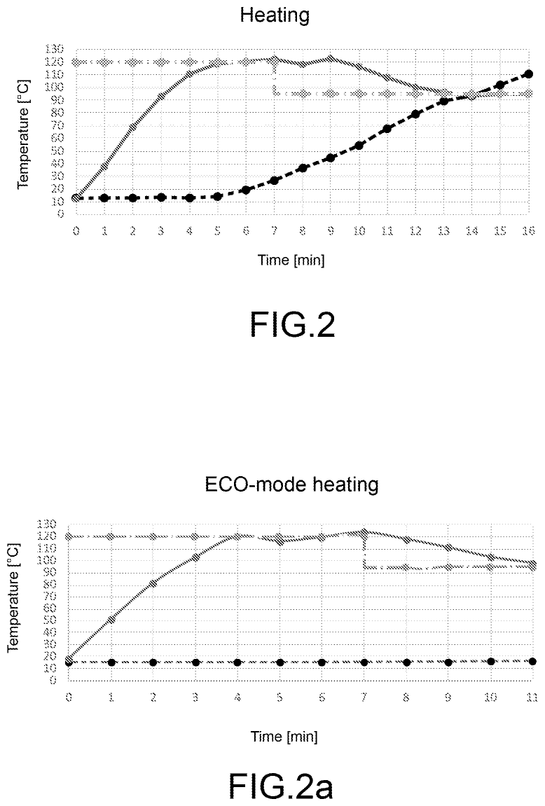

FIGS. 2 and 2a are time-temperature diagrams showing the trend of the temperature curves of the main boiler and the secondary boiler in the case of standard operation with both boilers active and in the case of the main boiler active, eco-operation with only respectively, when the initial temperature of the main boiler is between 0° C. and 40° C.;

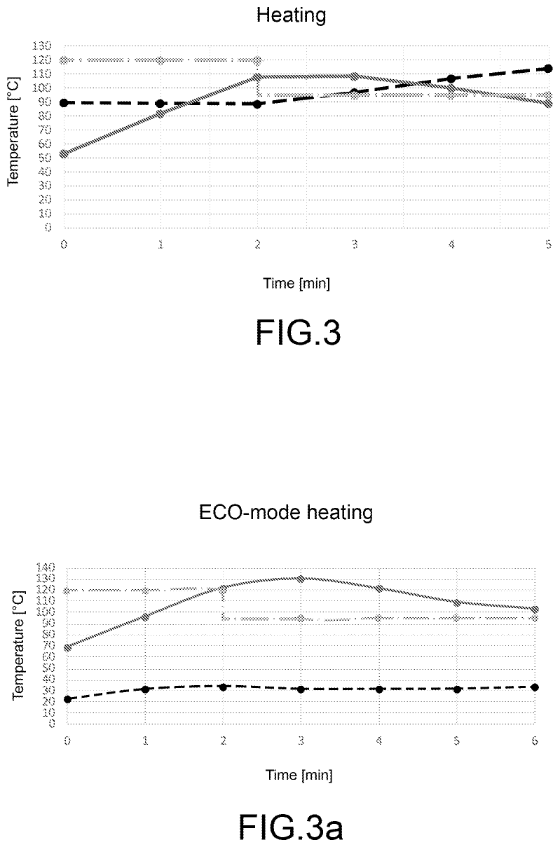

FIGS. 3 and 3a are time-temperature diagrams showing the trend of the temperature curves of the main boiler and the secondary boiler in the case of standard operation with both boilers active and in the case of eco-operation with only the main boiler active, respectively, when the initial temperature of the main boiler is between 41° C. and 64° C.;

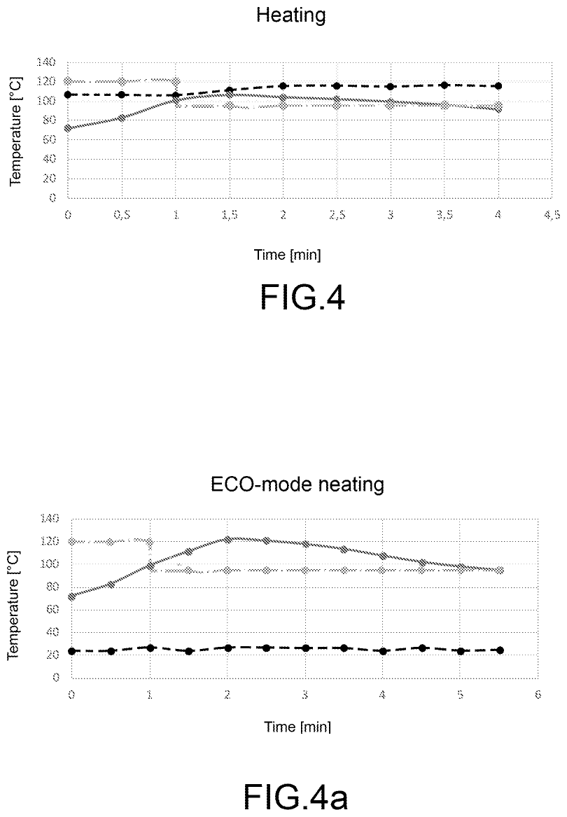

FIGS. 4 and 4a are time-temperature diagrams showing the trend of the temperature curves of the main boiler and the secondary boiler in the case of standard operation with both boilers active and in the case of eco-operation with only the main boiler active, respectively, when the initial temperature of the main boiler is between 65° C. and 75° C.; and

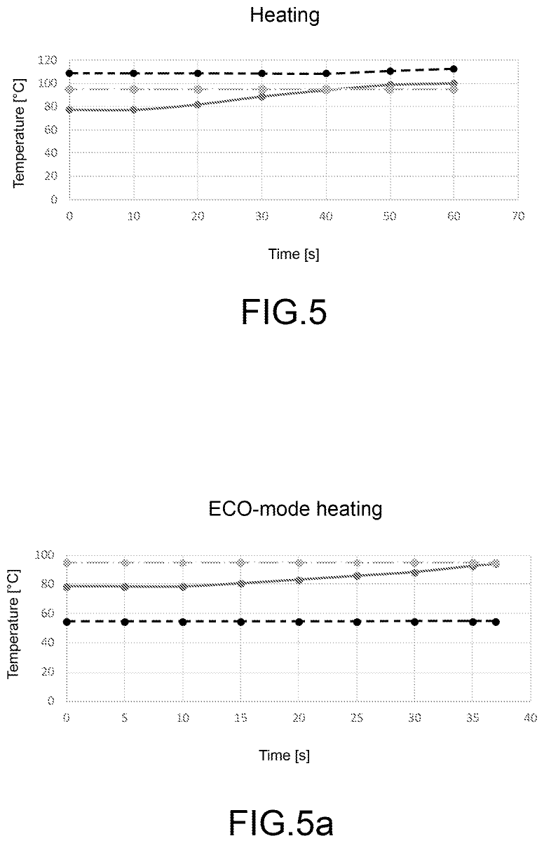

FIGS. 5 and 5a are time-temperature diagrams showing the trend of the temperature curves of the main boiler and the secondary boiler in the case of standard operation with both boilers active and in the case of eco-operation with only the main boiler active, respectively, when the initial temperature of the main boiler is greater than 75° C.

In said drawings, 100 is used to denote the hydraulic diagram of a machine for dispensing an infusion beverage in the entirety thereof.

In a general embodiment, the machine 100 is suitable for dispensing an infusion beverage such as coffee, chamomile, tea, or herbal tea.

The machine 100 is provided with a reservoir 1 for the infusion liquid, for example water or milk, an alcoholic beverage or a combination thereof.

The machine 100 comprises a pumping group 2. For example, the pumping group 2 is a rotary pump, commonly used in coffee machines.

The machine 100 comprises one or more dispensing groups 5, 12. The pumping group 2 is suitable for pumping the infusion liquid from the reservoir 1 to the dispensing groups 5, 12, for example by means of controlling a distribution valve group 4.

In particular, the machine comprises a main dispensing group 5 for dispensing the infused beverage. For example, the main dispensing group 5 is of the type known as the E61® group and described in U.S. Pat. No. 3,314,357.

The machine 100 further comprises at least one main boiler 6. The main dispensing group 5 receives the heated infusion liquid from the main boiler 6.

The main boiler 6 is provided with main heating means 7, for example of an electrical type, for heating the infusion liquid supplied to the main boiler by the pumping group 2.

The machine 100 is equipped with a main temperature sensor 8 suitable for measuring the temperature of the infusion liquid in the main boiler 6 or exiting the main boiler 6.

For example, the dispensing group 5 comprises, or may be connected to, a filtration member suitable for containing an organic substance that may be wetted by the infusion fluid so as to obtain the corresponding infusion beverage to be dispensed. In particular, the filtration member is a portafilter that contains in its interior a filter where the coffee is inserted.

In one embodiment, the machine 100 is provided with a secondary dispensing group 12, comprising for example a water tap 13 and/or a steam tap 14.

The machine 100 comprises a secondary boiler 16. The secondary dispensing group 12 receives the steam or the infusion liquid heated by the secondary boiler 16.

The secondary boiler 16 is provided with secondary heating means 17, for example of an electrical type, for heating the infusion liquid supplied to the secondary boiler 16 by the pumping group 2.

The machine 100 is equipped with a secondary temperature sensor 18 suitable for measuring the temperature of the infusion liquid in the secondary boiler 16 or exiting the secondary boiler 16.

In one embodiment, the machine 100 is provided with a user interface—not shown—suitable for receiving from a user a desired target temperature value for the infusion liquid.

The target temperature value for the infusion liquid may be preset by the machine manufacturer (and therefore already stored in the machine) and may possibly be changed by the user.

Similarly, if the secondary dispensing group 12 is also present, a target temperature value for the service liquid and/or steam is also defined. This target temperature value may also be preset by the manufacturer and/or the user.

Furthermore, if the secondary dispensing group 12 is also present, the user interface is suitable for allowing the user to select a standard operating mode, wherein both of the boilers 6, 16 are active, or an “eco” operating mode, or energy saving mode, wherein only the main boiler 6 is active.

The machine 100 is controlled by an electronic control unit—not shown—operatively connected to the main heating means, to the secondary heating means (if present), to the main temperature sensor, and to the secondary temperature sensor (if present).

The electronic control unit may also be connected to the user interface in order to receive from the user the desired target temperature value for the infusion liquid and/or the service liquid and/or the mode of operation of the machine.

The electronic control unit is programmed to control the main heating means 7, and possibly the secondary heating means 17, so as to implement a heating cycle of at least the infusion liquid and the main dispensing group as a function of the temperature of the main boiler 6 at the time of the activation or re-activation thereof.

In particular, the electronic control group is programed to acquire from the main temperature sensor the initial temperature value of the infusion liquid.

If the initial temperature value is lower than an initial threshold temperature between 60° C. and 80° C., for example lower than 75° C., the electronic control unit is programmed to perform a first step of infusion liquid overheating, wherein the main heating means are controlled for a predetermined interval of time so as to aim at a set-point temperature value that is greater than the desired target temperature value.

In one embodiment, the duration of the predetermined time interval is dependent upon the initial temperature value.

At the end of the first infusion liquid overheating step, the electronic control unit performs a second target tracking step, wherein the main heating means are controlled so as to aim at the target temperature value, i.e., in order to bring the infusion liquid to the desired target temperature (as pre-set by the manufacturer or set by the user).

For example, during this second step, the main heating means 7 are controlled in a closed loop, for example using PID control.

It should be noted that the duration of the first infusion liquid overheating step is chosen in such a way as to bring the infusion liquid to a temperature that is significantly higher than the target temperature (as in the examples below), this greater temperature being close to, but not necessarily coincident with, the set-point temperature.

In some embodiments, for example when the initial temperature is low, i.e. substantially equal to the ambient temperature insofar as the machine is activated after a long time interval, the duration of the first overheating step is chosen so as to bring the infusion liquid to the set-point temperature and to possibly maintain the liquid at this set-point temperature for a certain time interval.

In fact, the control algorithm of the main heating means has been designed to optimize not only the heating time of the infusion liquid in the main boiler and possibly of the liquid present in the secondary boiler, but also the heating time of the main dispensing group (and of the secondary group, if present), or the time necessary in order to reach the “machine ready” condition. This condition occurs in fact when not only the infusion liquid has reached the desired target temperature, but also when the relative dispensing group has reached this temperature. Otherwise, in fact, a dispensing group that is colder than the temperature of the infusion liquid in the boiler would cause the liquid to cool during the dispensing thereof.

As may be appreciated from the trend of the temperature curve of the infusion liquid shown in the graphs, after the infusion liquid has reached a temperature value close to or equal to the set-point value, and also for a certain time from the starting moment of the second target temperature tracking step, the infusion liquid remains overheated at a temperature higher than the target temperature value and may therefore transfer the excess heat to the dispensing group.

For example, the heat is transferred from the main boiler to the hydraulic circuit and in particular to the dispensing group by means of a radiator circuit.

When the electronic control unit acquires from the main temperature sensor a signal that the desired target temperature value has been reached, the electronic control unit may inform the user that the machine is ready to activate the dispensing of the beverage.

As explained above, the temperature parameters and/or duration of the (over) heating cycle of the infusion liquid are chosen in such a way that, when the desired target temperature is reached, the entire machine system, and in particular the dispensing group, will be substantially at the same target temperature.

Examples of heating cycles are described hereinafter with reference to FIGS. 2-5. In particular, the attached graphs show the heating curve of the infusion liquid (solid line), the heating curve of the liquid in the secondary boiler (dashed line) and the curve representative of the set-point values set for the first heating means control software (line with dashes and dots).

### Example 1: Initial Temperature of the Main Boiler Between 0-40° C. (FIGS. 2 and 2a)

The main heating means 7 are activated, for example at maximum power and without closed loop control, for 7 minutes by setting a set-point temperature of 120° C.

It should be noted that the set-point is reached at around the fifth minute and that for the remaining two minutes the main heating means remain active in order to maintain the infusion liquid the at set-point temperature.

After the 7 minutes have elapsed, the main heating means are controlled so as to follow the target temperature set by the user, for example 95° C.

If the secondary boiler 16 is present and if the machine is in standard mode (FIG. 2), then when the main heating means are not active or are operating at reduced power, in particular during the second target temperature tracking step when the temperature of the infusion liquid is even higher than the target temperature, the secondary heating means 17 are activated.

The control unit waits to receive from the main temperature sensor (and from the secondary temperature sensor, if present and if the machine is in standard mode) information regarding the fact that the temperature of the main boiler (and of the secondary boiler, if present and active) is equal to the desired target temperature (less than a tolerance range, for example + or −2° C.).

Only when this information is received will the electronic control unit inform the user that the machine is ready to start dispensing the beverage.

As may be seen from the graph in FIG. 2, when both boilers are active (standard mode), the main boiler reaches the target temperature (for example 95° C.) in about 14-15 minutes. Meanwhile, the secondary boiler was also heated by the activation of the secondary heating means 17 and brought to a preset temperature (from the manufacturer or subsequently from the user, for example 110° C.) in about 16 minutes.

When the machine is operating in eco-mode (FIG. 2a), the time required to bring the main boiler to the desired target temperature is further reduced to 11 minutes.

### Example 2: Initial Temperature of the Main Boiler Between 41-64° C. (FIGS. 3 and 3a)

The main heating means 7 are activated, for example at maximum power and without closed loop control, for two minutes by setting a set-point temperature of 120° C.

After the two minutes have elapsed, the main heating means are controlled so as to follow the target temperature set by the user, for example 95° C.

It should be noted that between the second and third minutes the infusion liquid reaches and remains at a temperature of about 108° C.

If the secondary boiler 16 is present and if the machine is in standard mode (FIG. 3), then when the main heating means are not active or are operating at reduced power, in particular during the second target temperature tracking step when the temperature of the infusion liquid is even higher than the target temperature, the secondary heating means 17 are activated.

The control unit waits to receive from the main temperature sensor (and from the secondary temperature sensor, if present and if the machine is in standard mode) information regarding the fact that the temperature of the main boiler (and of the secondary boiler, if present and active) is equal to the desired target temperature (less than a tolerance range, for example + or −2° C.).

Only when this information is received will the electronic control unit inform the user that the machine is ready to start dispensing the beverage.

As may be seen from the graph in FIG. 3, when both boilers are active (standard mode), the main boiler reaches the target temperature (for example 95° C.) in about 5 minutes. Meanwhile, the secondary boiler was also heated by the activation of the secondary heating means 17 and brought to a preset temperature (from the manufacturer or subsequently from the user, for example 110° C.).

### Example 3: Initial Temperature of the Main Boiler Between 65-74° C. (FIGS. 4 and 4a)

The main heating means 7 are activated, for example at maximum power and without closed-loop control, for one minute by setting a set-point temperature of 120° C.

The infusion liquid reaches, between the first and the second minute, a maximum temperature of about 106° C., with a delta of over 30° with respect to the initial temperature, which is sufficient however to heat the dispensing group in a reduced time (taking into account that the starting temperature is already high, about 70° C.).

If the secondary boiler 16 is present and if the machine is in standard mode (FIG. 4), then when the main heating means are not active or are operating at reduced power, in particular during the second target temperature tracking step when the temperature of the infusion liquid is even higher than the target temperature, the secondary heating means 17 are activated.

The control unit waits to receive from the main temperature sensor (and from the secondary temperature sensor, if present and if the machine is in standard mode) information regarding the fact that the temperature of the main boiler (and of the secondary boiler, if present and active) is equal to the desired target temperature (less than a tolerance range, for example + or −2° C.).

Only when this information is received will the electronic control unit inform the user that the machine is ready to start dispensing the beverage.

As may be seen from the graph in FIG. 4, when both boilers are active (standard mode), the main boiler reaches the target temperature (for example 95° C.) in about 4 minutes. At the same time, the secondary boiler has also been brought to the factory-set or user-modified temperature.

If the initial temperature of the main boiler is greater than 75° C. (FIGS. 5, 5a), the electronic control unit controls the main heating means so as to follow the target temperature value set by the user.

The control unit informs the user that the machine is ready to dispense the beverage when it receives information from the temperature sensors regarding the fact that the target temperature value has been reached (less than a tolerance range, for example of + or −2° C.).

As may also be seen from the graphs of the accompanying figures, the time required in order to heat the infusion liquid to the desired temperature has been significantly reduced (for example from 20 to 16 minutes if both boilers are active or to 11 minutes if only the main boiler is active).

The greater speed in reaching the target temperature set by the user is not to the detriment of the organoleptic qualities of the beverage dispensed, insofar as this greater speed is due to the first step of controlling the main heating means, wherein the software forces the heating means to target a higher temperature than that desired and which will be maintained only for the time necessary in order to also heat the dispensing group.

The target temperature is reached starting from the set-point temperature in a slow and gradual way, as may be seen for example by the shape and slope of the heating curve in the range from the 10° to 16° minute (in the standard case of both boilers being active).

A person skilled in the art may make several changes and adjustments to the embodiments of the machine and to the method for dispensing an infusion beverage according to the present invention and replace elements with other functionally equivalent ones in order to meet incidental needs, without departing from the scope of the following claims. Each of the features described as belonging to a possible embodiment may be obtained independently of the other described embodiments.

1. A machine for dispensing a hot infusion beverage, comprising:
at least one main boiler provided with main heating means for heating an infusion liquid;
a main temperature sensor suitable to measure a temperature of the infusion liquid in the main boiler or exiting the main boiler;
at least one main dispensing group in fluidic communication with the main boiler; and
an electronic control unit operatively connected to the main heating means and to the main temperature sensor and programmed to control the main heating means so as to implement a heating cycle for heating the infusion liquid and the main dispensing group, the heating cycle comprising:
acquiring, from the main temperature sensor, an initial temperature value of the infusion liquid; and
if the initial temperature value is lower than an initial threshold temperature from 60° C. to 80° C., executing a first infusion liquid overheating step, wherein the main heating means are activated to aim at a set-point temperature value greater than a target temperature value preset by a user or by a manufacturer, said first infusion liquid overheating step having a predetermined duration as a function of the initial temperature value.

2. The machine of claim 1, wherein the heating cycle comprises, at the end of the first infusion liquid overheating step, a target temperature tracking step, wherein the main heating means are controlled so as to aim for the target temperature value.

3. The machine of claim 1, wherein the electronic control unit is programmed to control the main heating means to a maximum power thereof and without a closed-loop control in the first infusion liquid overheating step.

4. The machine of claim 1, wherein the set-point temperature value and/or the duration of the first infusion liquid overheating step are selected so that excess heat accumulated by the main boiler is sufficient to bring the main dispensing group to the target temperature value.

5. The machine of claim 1, wherein the set-point temperature value is about 120° C.

6. The machine of claim 1, wherein the electronic control unit is programmed to set a duration of the first infusion liquid overheating step of about 7 minutes if the initial temperature value is from 0° C. to about 40° C.

7. The machine of claim 1, wherein the electronic control unit is programmed to set a duration of the first infusion liquid overheating step of about 2 minutes if the initial temperature value is from 40° C. to about 65° C.

8. The machine of claim 1, wherein the electronic control unit is programmed to set a duration of the first infusion liquid overheating step of about 1 minute if the initial temperature value is from 65° C. to about 74° C.

9. The machine of claim 1, further comprising
a secondary boiler provided with secondary heating means for dispensing steam and/or heating a service liquid;
a secondary temperature sensor suitable to measure the temperature of the infusion liquid in the secondary boiler;
wherein the electronic control unit is operatively connected to the secondary heating means and to the secondary temperature sensor and the electronic control unit is programmed to activate the secondary heating means so as to reach a target temperature value for the service liquid and/or the steam set by the user or by the manufacturer when the main heating means are inactive or operating at a lower power than the maximum power.

10. A method for controlling a machine for dispensing a hot infusion beverage by a dispensing group, the method comprising an infusion liquid overheating step, wherein an infusion liquid is heated in a main boiler at a greater temperature than a target temperature value set by a user or by a manufacturer, so that excess heat accumulated by the infusion liquid is transferred to the dispensing group to bring the dispensing group to the target temperature value.

11. The method of claim 10, wherein the excess heat is transferred to the dispensing group by a radiator circuit.

12. The method of claim 10, wherein the infusion liquid overheating step has a predetermined duration as a function of an initial temperature value of the infusion liquid.

13. The method of claim 11, wherein, at the end of the infusion liquid overheating step, a target temperature tracking step is carried out to bring the infusion liquid to the target temperature value.

14. The method of claim 10, wherein the infusion liquid overheating step is carried out supplying main heating means for heating the infusion liquid to a maximum power thereof and without a closed-loop control.

15. The method of claim 10, further comprising a step of heating a service liquid by heating means of the service liquid, wherein said heating means of the service liquid are activated at the end of the infusion liquid overheating step.

16. The machine of claim 1, wherein the hot infusion beverage is coffee, chamomile, tea, or herbal tea.

17. The method of claim 10, wherein the hot infusion beverage is coffee, chamomile, tea, or herbal tea.
